(19) United States
(12) Patent Application Publication
(10) Pub. No.: US 2006/0206622 A1
(43) Pub. Date: Sep. 14, 2006

(54) Methods and apparatus for data routing and processing

(75) Inventors: Robert Peter Noble, Wake Forest, NC (US); Donald A. Bradley, Raleigh, NC (US); Debra S. Lely, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC (US)

(21) Appl. No.: 11/077,749

(22) Filed: Mar. 11, 2005

(51) Int. Cl. G06F 17/30; G06F 15/173; G06F 12/00

(52) U.S. Cl. 709/238; 707/200

(57) ABSTRACT

Systems and techniques for data management and routing. Associated collections of information comprising data and associated documents are received, with the documents in each grouping of information being able to be received in one of a variety of formats. Each collection of information that is received is assembled into an information package, and the data and documents in each information package are further assembled into a transfer package in a standardized format for processing. Each document is translated into a standardized format with the standardized format being independent of the format in which the document is received.

### FIELD OF THE INVENTION

The present invention relates generally to advantageous aspects of systems and techniques for the processing and assembly of information. More particularly, the invention relates to systems and techniques for receiving information in a variety of formats and managing routing and processing of the information.

### BACKGROUND OF THE INVENTION

Many complex transactions involve the processing, assembly and routing of large amounts of data, including large numbers of documents. One type of transaction that involves such processing and assembly of data is mortgage loan processing and approval. A mortgage loan application and the processing, approval and funding of the loan involves the receipt and examination of substantial amounts of data which is often initially received in a wide variety of formats. Once received, this data may be organized into a package of data relating to a particular transaction, and the processing of the transaction may often advantageously be divided among a number of processing centers. Data and documents contained in or associated with the package are routed to processing centers. Routing is typically performed according to some set of predetermined criteria. The criteria typically include an appropriate distribution of the workload among processing centers, timely processing of various package elements and a proper time sequence of processing. A proper time sequence includes completing processing steps earlier in the sequence if the results of those processing steps are required in order to accomplish processing steps that occur later in the sequence.

Some information, such as identifying and financial information relating to the applicant, and data relating to the receipt and disbursement of funds, is stored in machine readable format, for example in the form of one or more editable text documents. Other information typically consists of documents that provide evidence for or give legal force to a transaction, for example, signed affirmations, property descriptions and the like. This data is typically stored in the form of document images.

Mortgage processing may be performed by large organizations serving a wide variety of customers. Customers may wish to provide data using their own systems and formats, but when the data is processed, it is convenient to manage the data in the same format and in the same way. Prior art systems typically require considerable manual intervention in order to translate data and documents that may appear in any of a variety of formats into a single format for processing, or alternatively to deal with information appearing in different formats.

### SUMMARY OF THE INVENTION

Among its several aspects, the present invention recognizes that there is a need for systems and approaches for automatically receiving data presented in different formats from different sources and automatically translating and managing the data so that equivalent data appears in an equivalent format and so that data from all sources is compatible and can be managed by a single system. A further need exists to organize and route this data so as to facilitate efficient and timely processing.

A data management system according to an aspect of the present invention comprises an interface module for receiving information to be processed in order to carry out a transaction, such as mortgage processing, for example. The information is stored in the form of information packages and comprises associated collections of editable data and document images. Each collection is able to be received independently from one of a plurality of independent sources. A source is typically an entity, such as a mortgage lender, submitting the data for processing in order to facilitate a transaction. Each source provides information for processing in order to facilitate a transaction in which the entity acting as the source is engaged. The document images are able to be received in any of a variety of formats. Each source from which information may be received provides documents in its own formats independently of other sources. The system further comprises a package management module operative to organize the information packages for routing and processing. The package management module is operative to translate each document to a standardized format regardless of the particular format in which the document was received. The package management module is also operative to store each information package in a standardized format for processing. Ultimately, processing is able to be carried out independently of the format in which the information comprising the package was received.

A process of data management according to an aspect of the present invention comprises the steps of receiving one or more associated collections of information comprising data and associated documents, with the documents in each grouping of information being able to be received in one of a variety of formats. The process further comprises assembling each grouping of information received into an information package and assembling the data and documents in each information package into a transfer package in a standardized format for processing. Each document is translated into a standardized format regardless of the format in which the document is received.

A more complete understanding of the invention, as well as further features and advantages of the invention, will be apparent from the following Detailed Description and from the claims which follow below.

### BRIEF DESCRIPTION OF THE DRAWINGS

FIG. 1 illustrates a system for managing data according to an aspect of the present invention;

FIG. 2 illustrates a process for managing data according to an aspect of the present invention;

FIG. 3 illustrates additional details of a system for managing data according to an aspect of the present invention;

FIG. 4 illustrates a process of data retrieval, translation and routing according to an aspect of the present invention;

FIG. 5 illustrates an interface form used for data entry and retrieval according to an aspect of the present invention;

FIG. 6 illustrates an interface form used to examine processing queue information for data processing conducted according to an aspect of the present invention; and

FIG. 7 illustrates a presentation page used to display report information describing processing activities for data processing conducted according to an aspect of the present invention.

### DETAILED DESCRIPTION

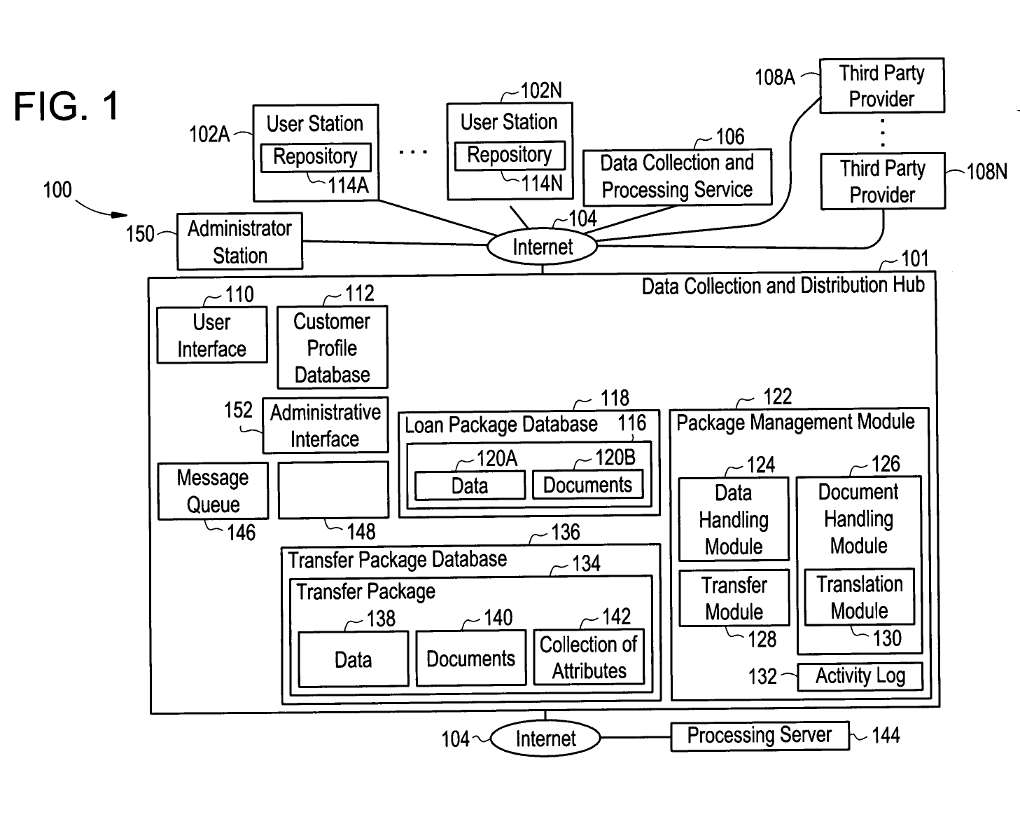

FIG. 1 illustrates a data management system according to an aspect of the present invention. While the system 100 is illustrated here as a mortgage processing system, it will be recognized that a system similar to the system 100 may be employed for management of any data that may be received in diverse formats but processed in a common format. The system 100 includes a data collection and management hub 101 operating to receive data from a variety of sources. Sources may include customers by or for whom data is submitted for processing, users acting as employees of customers, third party providers supplying information in support of customer transactions, and any of a number of other sources. In the context of mortgage processing, customers may include, for example, mortgage brokers and lending institutions, and third party providers may include, for example, entities such as credit reporting agencies, mortgage insurance providers and other entities providing information used in support of mortgage processing transactions.

Many sources from which data may be received act independently of one another and the data from one independent source is processed without regard to data formats and preferences used by other independent sources.

The hub 101 serves a plurality of user stations 102A . . . 102N. The user stations are typically operated by employees of customers, such as mortgage lenders or brokers, for which loan processing services are provided. The hub 101 may communicate with the user stations 102A . . . 102N using any desired means for communication, but communication is illustrated here for exemplary purposes as being conducted over the public Internet 104. The user stations 102A . . . 102N may include terminals, computer networks, data repositories or any other suitable device or combination of devices that may be employed by the entity operating the user stations 102A . . . 102N. The hub 101, as well as the user stations 102A . . . 102N, may also communicate with a data collection and processing service 106, as well as a plurality of third party providers 108A . . . 108N.

The hub 101 suitably hosts a user interface module 110, as well as a customer profile database 112. The customer profile database 112 includes a plurality of customer profiles such as the customer profile 113, with each profile including customer preferences and loan processing instructions. The customer preferences may suitably include formats for data and document formats. For example, a customer may store document images in the form of joint photographic experts group (“jpg”) files and tagged image format (“tif”) files, and images provided to the hub 101 by users or entities associated with that customer may be provided in this format. In such a case, the customer profile associated with the customer will include specifications that these formats will be the formats for documents provided by or for the customer.

Typically, in preparing and presenting loan information for processing using the hub 101, information is collected and stored in a customer information repository, for example the repository 1 14A associated with the user station 102A. The information typically includes data in editable format, as well as document images. The documents are in a format chosen by the customer and supported by customer equipment. Different customers may provide documents in different formats, and the same customer may provide documents in several different formats.

The data stored in editable format may suitably include information collected in connection with a loan application and stored in editable format for processing. Examples of data include name, address and other identifying information for the borrower, financial information relating to the borrower, address and valuation information relating to the property to be financed, and other information. Additional information may include credit report information and mortgage insurance commitment information. Such information may be provided by a third party provider such as the provider 108A. The information may be provided in response to the requests or data furnished by the customer, either directly from a user station such as the station 102A or through the use of the data collection and processing service 106. The data may be delivered by the third party provider 108A to the user station 102A or, if desired, to the hub 101, either directly or through the data collection and processing service 106.

In addition to the editable data, a number of document images are also collected, because some documents supplementing or authenticating information and statements made in connection with a loan application customarily include images that must be presented for examination. Examples of such documents include property descriptions, and the property descriptions may include drawings of property boundaries. Other examples of documents include photographs or video files supporting an appraiser's valuation of a property. Further examples of documents include documents bearing a signature. Examples of documents bearing signatures include applications, statements and agreements signed by a borrower and statements signed by parties providing information about a borrower, such as an income confirmation provided and signed by a borrower's employer. These documents are gathered and organized by the hub 101 in such a way as to facilitate their use in processing the loan transaction.

When a user is ready to submit loan information for processing, the user issues a notification to the hub 101. To take an example for purposes of illustration, suppose that the borrowers Reed Richards and Susan Storm, a married couple, have applied for a home loan at the Bailey Building and Loan Company, or Bailey B&L. Bailey B&L maintains the user station 102A and is a customer of the entity operating the hub 101. Bailey B&L submits loan applications for processing through the hub 101 and receives information, including status updates and processing results, and requests for additional documents or information, through the hub 101. The customer profile database 112 hosts the profile 113, which includes processing preferences and instructions for submissions received from Bailey B&L, and includes descriptions of documents and data that Bailey B&L submits in connection with a typical transaction, as well as formats in which those documents may be received.

The customer profile 113 may be constructed in any of a number of different ways. For example, the information stored in the profile 113 may be entered directly by an operator, with specific entries being made for various preferences and choices. Alternatively, the profile 113 may be constructed through examination of a transaction model for Bailey B&L. The pattern of transactions engaged in by Bailey B&L can be examined, as well as the types and formats of information used in processing the transactions, and a model or models of typical transactions can be constructed. Choices and preferences can be taken from the model and stored in the profile 113.

In the present case, the hypothetical customer, Bailey B&L, supplies text documents in the form of MICROSOFT® WORD® document files and in the form of ordinary ASCII text files. The customer, or entities acting on behalf of the customer, supply photographs in the form of joint photographic experts group (“jpg”) files, documents bearing drawings and signatures in the form of tagged image format (“tif”) files, and video files in the form of audio video interleave (“avi”) files. Preferences may include instructions for routing and processing of data and documents. In addition, or as an alternative, to being presented in the customer profile 113, preferences and instructions used in processing a package may be taken from user instructions provided at the time of submission, or taken from default sets of instructions to be used in particular categories of cases.

In the present exemplary case, the customer profile 113 provides information relating to document categories and formats for loan packages submitted for processing by Bailey Building and Loan. In the present exemplary case, the customer profile also provides transfer and processing instructions. These instructions indicate conditions under which a transfer is to be made as well as processing preferences. In this case, processing preferences include a listing of three preferred underwriters, with loan packages to be submitted to one of these underwriters for approval, if possible. The following table presents one possible information layout for the information provided by the customer profile 113:

Customer: Bailey Building and Loan

| Editable Data Category | | Editable Data Format |
|---|---|---|
| Borrower personal and financial information | | Word, ASCII |
| | Document Category | Document format |
| | Property title reports | tif |
| | Signed affirmations | tif |
| | Appraiser digital photographs | jpg |
| | Appraiser video | avi |

| | |
|---|---|
| Transfer instructions | Transfer once Borrower personal and |
| | financial information and signed |
| | affirmations are received |
| Processing instructions | Preferred underwriters: Potter Megabank; |
| | Marley Bank and Trust; Midas Finance |

When a borrower or borrowers initiate a loan application with a customer of the entity maintaining the hub 101, the customer collects and assembles information relating to the loan application. In the present example, Bailey B&L assembles information relating to the borrowers, Reed Richards and Susan Storm, and the property they propose to finance. This information includes personal and financial information taken from a loan application submitted by the borrowers. This information is in MICROSOFT® WORD® format. Bailey B&L also collects and assembles property records including a legal description of the property to be financed, and various affirmations and agreements signed by the borrowers. These documents are in tif format. Additional documents and data may also be collected. Such data and documents include information such as credit reports and mortgage insurance information and commitments, received from third party providers.

The editable files and the documents associated with the loan transaction are stored in the repository 114A. When the loan is to be submitted for processing through the hub 101, a user employed by Bailey Building and Loan employs the user station 102A to issue a notification that a loan package is to be submitted for processing.

Upon detecting the notification, the hub 101 invokes the user interface module 110, and the user interface module 110 retrieves the information from the repository 114A. The information is organized into a loan package, in this case the loan package 116, and stored in a loan package database 118. The loan package 116 includes a data section 120A, storing the data that has been provided in editable format, and a document section 120B, storing the document images. In the present example, the editable data includes the borrower information taken from the loan application, and the documents include the property records and signed affirmations and agreements.

The hub 101 manages processing of loan packages. Each loan package is organized so that the data and documents making up the package appear in a standardized format, regardless of the format in which the data and documents were received.

The hub 101 therefore hosts a package management module 122, comprising a data handling module 124, a document handling module 126 and a transfer module 128. The document handling module 126 includes a translation module 130. The package management module also includes an activity log 132.

Each data element, such as a data file providing editable data, and each document, is suitably assigned identifiers when the loan package is assembled, with the identifiers being stored as part of the loan package. For example, the various data elements and documents stored as part of the loan package 116 may be assigned identifiers showing the loan and the customer for whom or for which the loan is being processed. The identifiers typically accompany package elements during all stages of processing and are used to provide information relating to how the elements are to be processed and to identify the loan package to which each element belongs. Such identification helps to account for each element during processing and helps to make sure that the package is properly assembled at the completion of processing.

An example of an associated identifier may be a loan identifier, such as an identification number, for the loan with which a package element is associated. Identifiers may also include category identifiers, indicating a category to which a package belongs. A category identifier may, for example, identify a data element as a signature page of an application or a legal description of a property. A table presenting a representative sampling of data elements and accompanying identifiers for the present exemplary case is as follows:

| | | | Application |
|---|---|---|---|
| Data Element Category | Customer | Borrower | No. |
| Borrower information | Bailey B&L | Richards/Storm | 111111 |
| from application | | | |
| Property Information | Bailey B&L | Richards/Storm | 111111 |
| package | | | |
| Application Agreement | | | 111111 |
| and Signature Sheet | | | |
| Property Legal | Bailey B&L | Richards/Storm | 111111 |
| Description | | | |
| Appraiser Report | Bailey B&L | Richards/Storm | 111111 |
| Appraiser Photographs | Bailey B&L | Richards/Storm | 111111 |
| Appraiser Video | Bailey B&L | Richards/Storm | 111111 |

Documents may be received in any of a number of formats. Many different ways of creating documents are available, including faxing or scanning of paper documents, taking digital photographs, creating and storing an image directly using a computer or other data processing equipment, and numerous other ways of creating documents. In many cases, any of a number of different formats may be chosen for storage of documents created using the same general techniques. For example, numerous formats are available for faxed images. To allow for convenient use of the same processing techniques to process different packages that may include documents in different formats, it is advantageous to translate the documents into a standardized format for processing.

At the time of initial collection of data and assembly of the loan package 116, the documents associated with the loan package are in the original format in which they were received from the customer. In order to manage the loan package and distribute it for processing, the hub 101 preferably converts the documents to a standardized format consistent with the customer preferences, so that each document that is processed is in the same format as every other document of the same type, regardless of the loan package with which the document is associated or the customer submitting the document.

Therefore, the document handling module 126 uses the translation module 130 to translate documents to a standardized format. The translation module 130 includes a collection of tools so that all document formats used by customers can be translated. Tools may include, for example, image conversion tools operative to accept a document in one format and save the document in a different, specified format.

In order to select the particular tools and translation techniques for documents received from a particular customer, the translation module 130 uses customer information, such as information contained in the profile 113 stored in the customer profile database 112. This information is used to identify the particular formats being used by the customer. The translation module 130 uses the information provided by the profile 113 to select appropriate tools to be used for translation of each document, and to provide instructions for translation of the document. For example, information provided by the profile may be used to select a multiple format conversion tool, and to specify that the document to be converted appears in jpg format. The translation module 130 invokes and instructs translation tools as needed to translate each document of a particular type to the same standardized format. Similarly, elements of editable data may also be received in different formats from different customers. The data handling module 124 may perform appropriate conversions consistent with customer preferences so that data elements of the same type appear in the same format for processing.

The package management module 122 prepares each loan package for processing by organizing the data and documents in a standardized format to create a processing package. In the present example, the package management module 122 retrieves data from the loan package 116 and organizes this data to create a transfer package 134 to be transmitted for processing. Transfer packages are stored in a transfer package database 136.

The transfer package 134 includes a data section 138 and a document section 140. The data section 138 includes editable data retrieved from the loan package 116 and organized in a standardized format for processing. The document section 140 includes the documents retrieved from the loan package 116 and translated by the translation module 130.

The information in the transfer package 134 may include all or a subset of the information stored in the loan package 116. For example, the customer profile 113 may designate the items to be included in the package 134, or a user may select the items from a list of available items presented at the time the user initiates a transfer. If items that are not yet available are designated for inclusion in the transfer package, these items will be incorporated into the transfer package 134 when they become available. For example, an appraiser's report will not typically be available at initiation of a loan application. Data and documents included in such a report may be designated for inclusion and then will be retrieved once the report has been prepared and submitted.

Once the transfer package 134 has been created and stored, a transfer is initiated in order to transmit the transfer package 134 to a processing server 144. The transfer may be initiated by direct instructions from a user, or may be carried out according to predetermined instructions. Such predetermined instructions may include, for example, a set of default instructions for all customers or for particular categories of customers, with the instructions being maintained in an administrative database 148, used to store instructions, settings and preferences used to manage the operation of the hub 101. In addition or as an alternative, instructions for a specific customer may be included in the customer profile 113.

During preparation, transfer and processing of a package such as the package 116, messages may be received from and sent to a user such as the user operating the station 102A, or to an administrator operating an administrator station 150. Communication with an administrator may be managed by an administrative interface 152.

Messages to and from a user or administrator are stored in a message queue 146. The message queue 146 stores instructions and requests, as well as information to be reported to the user or to an administrator. A user or administrator may relay instructions or requests at any time, and the message queue 146 is periodically examined by the various modules, which act on requests or instructions as they are received. In addition, each module may periodically generate information to be reported to a user. This information is placed in the queue 146. The customer interface 110 periodically gathers information from the queue 146 and transmits reports to the user. The reporting may be done periodically or in response to user requests. In addition, information relating to events and activities for all users may be placed in the administrative database 148. Upon a query by an administrator, or at scheduled intervals for preparing reports, designated information is gathered and compiled into suitable reports by the administrative interface 152.

When a transfer is initiated, instructions initiating or governing the transfer may include destination information for the transfer, and may designate details of the processing to be performed. With the transfer operation, the user may provide instructions indicating data and documents to be transferred, with the instructions including a loan identifier and a list of document identifiers. Alternatively, instructions may be taken from the customer profile associated with the customer. Typically, the list of document identifiers includes a default or automatically assembled list, with a user being able to submit additional document identifiers if desired. It is possible that not all the documents needed for processing will be available at the initial assembly of the transfer package, and the list of document identifiers maintains an accounting of the documents that are needed, so that periodic queries can be made and newly available documents can be retrieved.

Once the transfer operation is initiated, the transfer module 128 examines the transfer package 134, the associated customer profile 113, and any instructions received from the user at the time of transfer. The transfer module 128 then determines if the processing package 134 includes sufficient information for the request to be executed. If sufficient information is not present, a request for additional data is routed back to the user, for example to the user station 102A. In addition, the transfer module 128 may examine potential destinations for the package in order to determine if a transfer is possible, and may accept or reject the transfer, sending an appropriate message to the user. This examination may be accomplished, for example, by querying the processing server 144 and receiving a report from the processing server 144 on the current workload of the potential destination or destinations for the package. The report may provide alternative destinations to which the package can be routed, or may report an estimated time when processing can be performed at the designated destination.

Once it has been established that sufficient data is present to allow for processing and transfer to a designated, or alternative, destination is possible, the transfer module 128 organizes the loan data and accompanying documents for routing and distribution. The transfer module 128 creates a collection 142 of attributes, with appropriate attributes being associated with each data item and each document. The attributes suitably identify the data items and documents and provide information such as the loan transaction with which each item is associated, the nature of each item, and preferences and instructions associated with each item and with the package as a whole. The attributes may suitably be created based on information taken from the customer profile 113, information provided by the user, or a combination of such information. The information provided by the user may include, for example, selections made at the time the transfer is initiated, or later or updated selections. Selections may include choices such as the destination to which a package is to be routed, preferred routing paths and selections of some or all of the operations to be performed in processing the package.

Once the transfer module 128 has created the attributes making up the collection 142, the transfer package 134 is transferred to the processing server 144. The processing server 144 directs routing and processing of the elements of the transfer package 134 as directed by attributes associated with each element. The processing server 144 suitably provides queuing and load balancing features, and may employ a FileNet™ processing environment or similar processing environment. It will be recognized, however, that numerous alternative processing environments may be selected or developed in order to provide services employed by the processing server 144.

Frequently, not all items required for completion of processing of a loan package are immediately available. New items may become available before a transfer has been initiated, or after the transfer has been initiated and processing has begun. As such items become available, they are stored in a data repository employed by the customer, and a message is submitted for inclusion in the message queue 146. Once the package management module 122 detects that the message is available, the documents are retrieved and the transfer package is updated. In the present example, the newly available items are stored in and retrieved from the repository 114A hosted by the user station 102A. Some of the items not initially available are an appraiser's report, submitted in Word format, together with photographs in jpg format and video in avi format.

In order to check for newly available documents, the transfer module 128 periodically examines the message queue 146 in order to detect messages indicating the availability of items designated in the list of item identifiers but not initially available. The items are then retrieved and stored in the loan package 116. The items are retrieved from the loan package 116, translated by the translation module 130 and added to the transfer package 134. The transfer module 128 then collects the items from the transfer package 134 and relays them to the processing server 144.

As each activity is performed, the action is logged in an activity log 132. The activity database 132 stores each activity performed once a loan package is submitted for storage in the loan package database 118, and includes acceptance or rejection of a loan package, for example the package 116, addition of documents to the loan package, translation of documents, receipt of and response to messages and commands and other activities that may be performed.

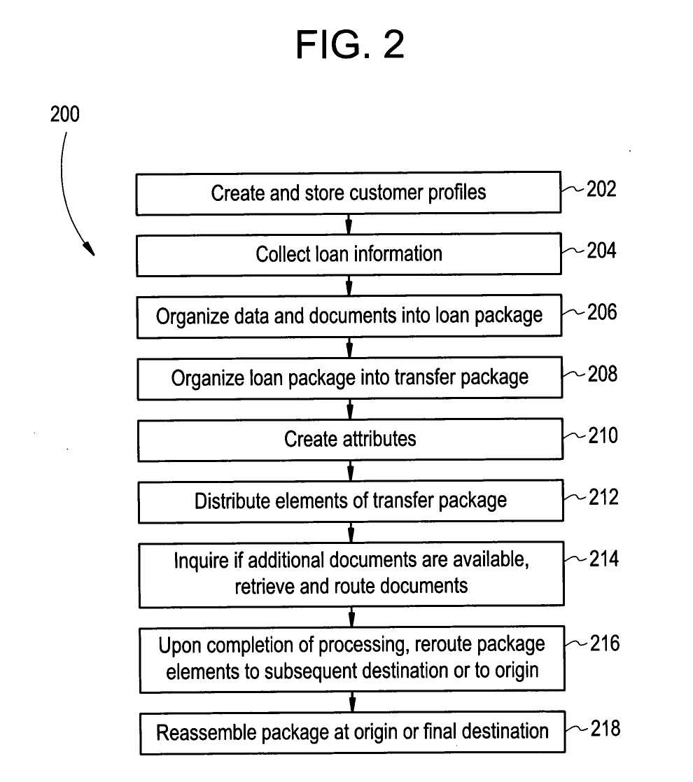

FIG. 2 illustrates a process 200 of data assembly and transmission according to an aspect of the present invention. The process 200 may suitably be implemented using a system similar to the system 100 of FIG. 1. The process 200 illustrated here deals with loan data submission and processing, but it will be recognized that the process 200 may easily be adapted to submission and processing of any type of desired data.

At step 202, a plurality of customer profiles are created and stored. A profile is created for each of a plurality of users. A customer's profile suitably includes user preferences and instructions for processing data received from the customer. The preferences and instructions may include identification of formats employed by the customer for storage of data, such as documents used in processing a loan application. The preferences and instructions may also include designations of preferred destinations for which data is to be routed for processing, preferences relating to report of progress to the user and any number of other items of information relevant to processing of data for the user. At step 204, upon receiving a notification from a user that processing of a loan package is desired, information relating to the loan package is collected. The information includes data stored in an editable format, as well as document images to be used in processing the loan. The information may suitably include a list of documents and data to be used in processing in order to provide notification of whether all required data and documents are being supplied at the initiation of processing. Alternatively, a list of the required data and documents may be stored in the customer profile associated with the customer.

At step 206, the data and documents are organized as a loan package, including data and documents in the form in which they were received from the user. At step 208, the loan package is organized into a transfer package including elements in standardized format, suitable for transfer to a distribution center capable of distributing elements of the loan package for processing and recovering each element upon completion of processing of that element and reassembly of the package after completion. The transfer package includes the data and documents, with each document being translated to a standardized format. Translation is guided by information stored in the user profile. Each customer is free to use its own desired format or formats for documents, and each customer profile includes information about the formats used in order to allow for proper translation of documents received from each customer. The transfer package also includes identifiers identifying data elements and document included in the package, with each identifier including an identification of the loan package with which the data elements and documents are associated.

At step 210, upon initiation of a transfer, attributes are created and associated with the data elements and documents in the transfer package, as well as the package as a whole. Initiation of a transfer may be accomplished by a specific instruction from a customer, or according to instructions in the customer profile, and may include selections influencing the routing and processing of the elements of the package. The attributes to be used in processing and routing of the package and the elements are assigned using general rules and customer instructions, if any. General rules may include rules governing routing decisions, for example preferring a closer routing destination, a destination with the lightest current workload or any of a number of other available choices. General rules may be supplemented or overridden by customer selections, with selections being taken from a customer profile and from customer selections made at initiation of a transfer. The attributes may suitably include destination information to indicate a destination for the package and operations information to indicate the processing operations to be performed on the package elements. The attributes may also include identifiers associated with each element currently associated with the loan package, as well as a list of identifiers for all data elements and documents that must be processed in association with the loan package. The list of identifiers includes identifiers for all documents currently submitted as well as identifiers for all document types needed, including those currently submitted and those that are not yet submitted but will eventually be needed for processing.

At step 212, the elements of the transfer package are distributed for processing in accordance with the associated attributes. At step 214, periodic inquiries are made to determine if additional documents needed for processing have been submitted and additional documents are retrieved, associated with identifiers and routing attributes and routed in accordance with the identifiers and attributes. At step 216, upon completion of processing of each element of the package, the element is rerouted to a subsequent processing destination or to its origin, depending on attributes associated with the element. At step 218, upon completion of processing of all elements of the package, the package is reassembled at its origin or at a final destination, as indicated by attributes associated with the package.

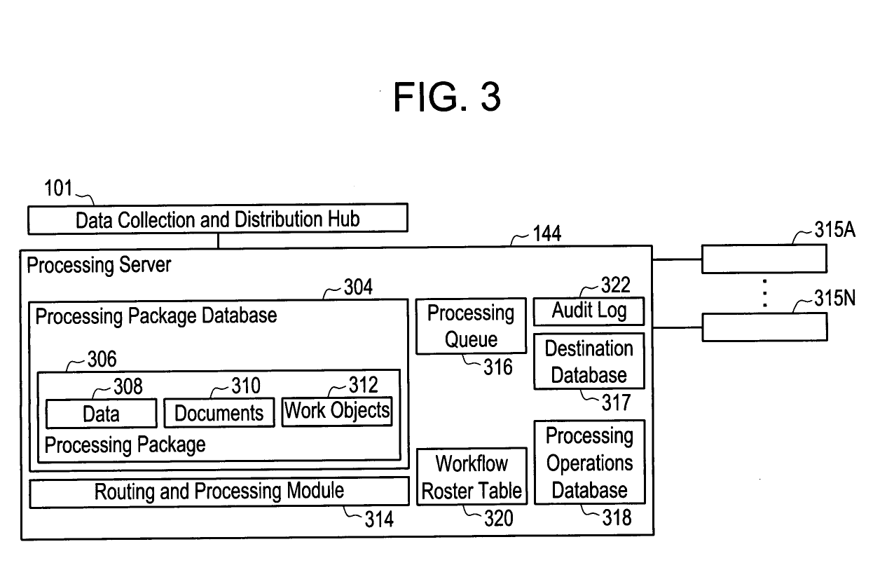

FIG. 3 illustrates additional details of the processing server 144, shown in communication with the hub 101. The processing server 144 supports a processing package database 304, hosting a plurality of processing packages such as the package 306. Each processing package is constructed upon transmission of a transfer package from the hub 101 to the processing server 144. For example, the package 306 is constructed upon transmission of the transfer package 134 from the hub 101 to the processing server 144.

The package 306 includes a data section 308, a document section 310 and a work object section 312. The processing server 144 includes a routing and processing module 314, which examines the data and documents stored in the data section 308 and the document section 310 and uses the data and documents, as well as attributes taken from the attribute collection of FIG. 1, to create work objects for routing and processing. A work object is a collection of data accompanied by instructions allowing it to be routed and processed independently. The processing server 144 communicates with a number of processing centers 315A . . . 315N. Work objects are routed to the processing centers in sequences defined by instructions contained in the work objects. For example, a work object may include instructions that it is to be routed to the center 315A, then the center 315E, then the center 315B. At each processing center, operations are performed on the work object according to instructions contained in the work object. Work objects that are awaiting routing are held in a processing queue 316. The processing queue 316 is accessible to each of the processing centers, and a work object may be delivered to an appropriate processing center automatically as the work object reaches an appropriate queue position. Alternatively, the queue 316 may be examined and a work object selected.

The processing server 144 also supports a destination database 317 and a processing operations database 318, used to interpret destination and processing instructions contained in various work objects. The processing server 144 additionally supports a workflow roster table 320. As each work object is routed and as each processing step is undertaken or completed, the workflow roster table 320 stores the routing and processing information, and the status of the work object and of the package as a whole. The status information may be used in directing the processing of one or more work objects, and also includes final results for the overall processing package. For example, in processing a loan application, many of the processing steps involve the review of information used in making a decision to approve or disapprove a loan. The result of a processing step involving verification of a borrower's income, for example, may include a decision that the information supplied is satisfactory, or a decision that more information is needed. The result of this decision is stored in the workflow roster table 320, and can be used when needed in the processing of other work objects. Status information is also accessible by the hub 101, which preferably conducts a periodic review of information contained in the workflow roster table 320 in order to provide updated status information to a user, as well as to determine if additional information is required. When additional information is needed, the package management module 122 places a message in the message queue 146. When the information is received, the transfer package associated with the request for information, for example the package 134, is updated. The updated package 134 is transferred to the processing server 144, which creates new or updated work objects or updates status information as appropriate.

The routing and processing information stored in the workflow roster table 320 provides insight into workloads of various processing centers and is used by the routing and processing module 314 in constructing each work object. For example, the routing and processing module preferably assigns work objects to processing centers in such a way as to balance the overall workload. For example, the routing and processing module 314 may tend to assign work objects to processing centers that are underused. To take another example, sometimes a first work object must be processed before a second work object can be processed. In such a case, the routing and processing module 314 will perform routing in such a way that the second work object is not submitted for processing before the first work object has been processed.

The workflow roster table 320 also stores origin or final destination information for each loan package to allow proper routing of elements back to their origin, or to an alternative final destination, once processing is complete. Each element of a loan package is suitably associated with an identifier for the package, with the identifier being stored in the workflow roster table 320 in association with the origin information. The routing and processing information, as well as substantive information reflecting the content and status of elements of the loan package, is monitored. As processing of each element of each loan package proceeds, the data stored in the workflow roster table 320 relating to the various loan package elements and the package as a whole is updated to reflect the disposition of the various elements. The processing server 144 also includes an audit log 322 to allow storage of the activity of the processing server 144 for review.

Once each work object has been constructed, the routing and processing module 320 is operative to route the work objects to one or more of the processing centers 315A . . . 315N, according to the instructions contained in the work objects. The work objects proceed through various processing stages, and are eventually returned to the processing server 144 where they are reassembled and routed to their final destination. For example, the work objects constructed from the package 306 may be reassembled on completion of processing. A message is then sent to the user station 102A, which is then able to retrieve the completed package 306.

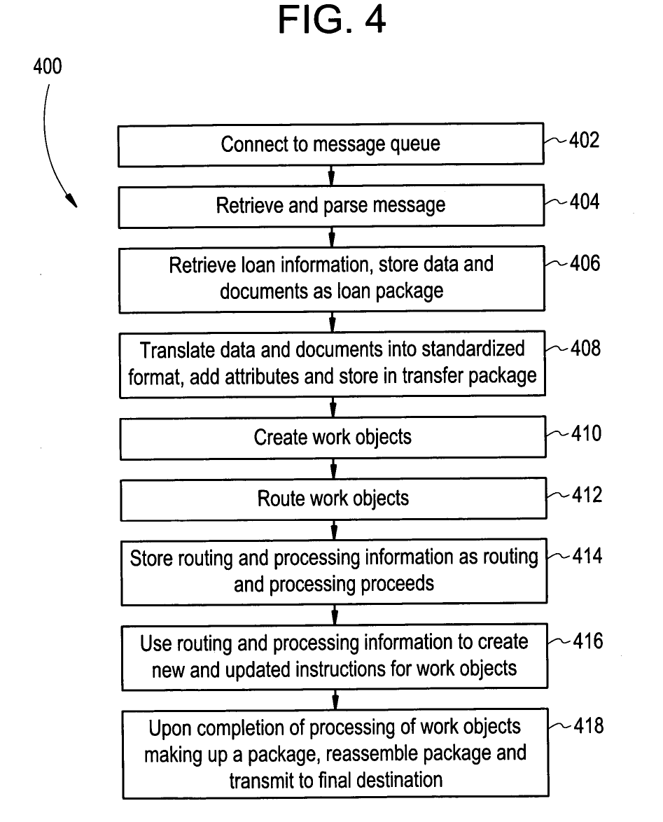

FIG. 4 illustrates the steps of a process 400 of data retrieval, translation and routing according to an aspect of the present invention. The process 400 may suitably be performed using the hub 101 of FIG. 1 and the processing server 144 of FIGS 1 and 3. At step 402, a connection is periodically made to a message queue used for transferring messages and instructions. At each connection, a predetermined wait period is allowed to elapse and an examination of the message queue is made. If a message is present, the process proceeds to step 404 and the message is retrieved and parsed in order to extract the message information. Message information may include a notification of the availability of loan transaction information.

At step 406, upon receipt of a message indicating the availability of loan transaction information, the information is retrieved and assembled into a loan package comprising editable data and document images. At step 408, the data and documents are converted to a standardized format, added to a transfer package and stored in association with attributes indicating instructions and preferences for processing of the data and documents. At step 410, work objects are created using the data and documents comprising the transfer package, with each work object including instructions prepared according to the attributes associated with the data and documents. The instructions may include instructions for standardized functions to be performed on each loan package element of a particular type, for example a property description or an appraisal. The processing information is typically taken from inputs received from a user, predetermined customer preferences or alternatively may be based on standardized operations for the type of document in question. The routing information may be based on customer inputs, but alternatively may be based on workload considerations, with routing information chosen based on an examination of the workload at each alternative destination, with a destination for each work object being chosen in order to balance workload and to achieve timely and convenient completion and assembly for each loan package.

At step 412, each work object is routed and processed in accordance with the instructions contained in the work object. At step 414, as each work object is routed and as each processing operation is undertaken, a notation or record of the routing and processing is stored in a centralized repository. At step 416, the routing and processing information in the repository is periodically examined and used to create instructions for new work objects and to update routing and processing instructions for existing work objects, if needed, as well as to prepare reports and messages describing the operations being undertaken and the status of the various loan packages. At step 418, upon completion of processing for the work objects comprising a package, the data and documents comprising the package are reassembled and transmitted to a final destination.

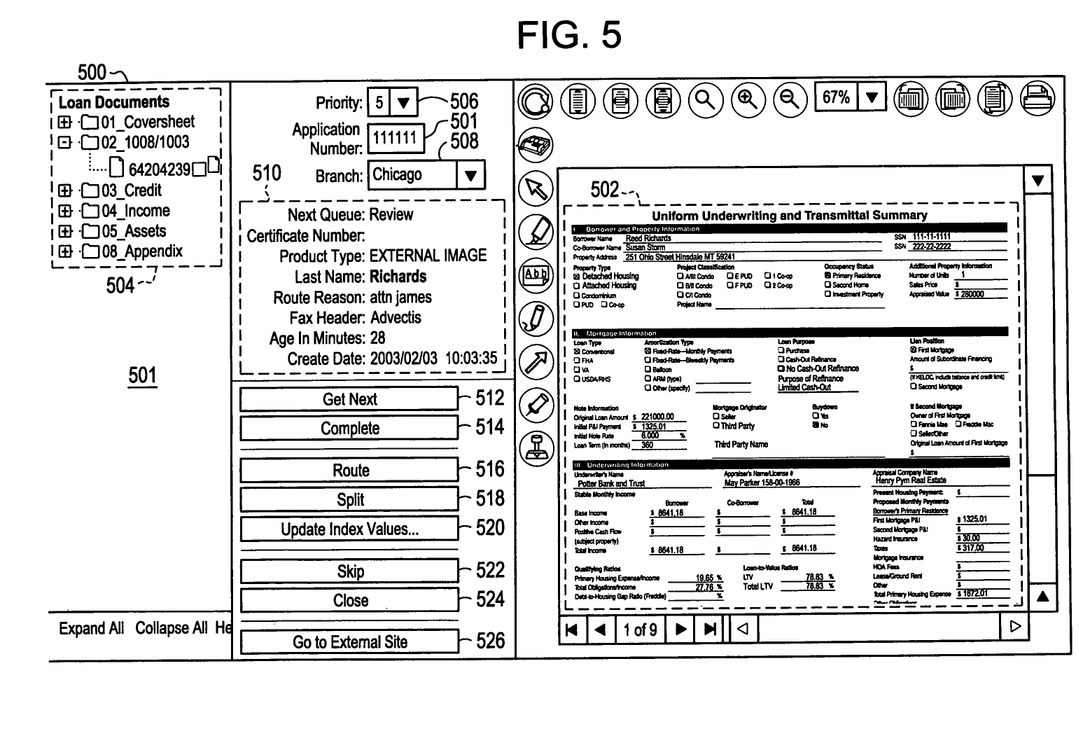

FIG. 5 illustrates a user interface form 500 used for submission and retrieval of data according to an aspect of the present invention. A user initiating a loan package may initiate the interface 500 using a customer station, for example the station 102A, in order to submit data. The interface 500 is also used to allow display of data and operations on data. The interface 500 displays an identifier, such as an application number 501, associated with a loan package. All data and documents associated with the loan package may be identified by the application number 501, and the interface 500 for a particular loan package provides access to all the data and documents identified with that package. The interface 500 displays editable data using a data form 502. The data form 502 is used to display borrower and property information, as well as details of the loan.

The form 502 also allows retrieval of documents associated with a loan package. The form 502 includes a document list 504, comprising a collection of folders showing various categories to which documents may be assigned. Opening one of the folders displays a list of documents, any of which may be displayed by selecting the name of the document, for example by clicking on the name. Selecting a document will open a document viewer to display the document in a separate window, and the window may be closed when the user is finished with the document.

The interface 500 also includes the capability to display and select routing information, including a priority pulldown menu 506 and a destination branch pulldown menu 508. The interface 500 also includes a package details display 510, showing various details of the creation of the package. The interface 500 also includes command buttons 512, 514, 516, 518, 520, 522, 524 and 526 for document retrieval and package routing commands.

The interface 500 provides a gateway to additional interfaces for data management and retrieval. For example, by entering an application number in the box 501 and activating the button 526, for example, by clicking on the button 526 with a computer mouse, invokes a page displaying information about the loan package identified by the application number.

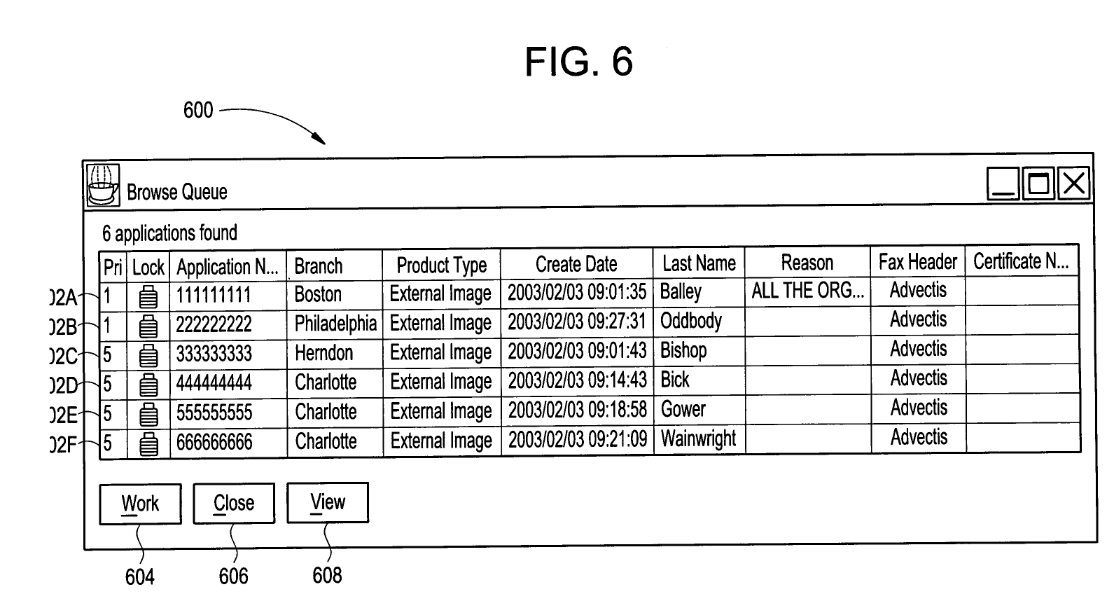

FIG. 6 illustrates a user interface display 600, preferably presented when a user at one of the processing centers 315A . . . 315N wishes to examine the processing queue 316. The display 600 is shown here as presenting work object records 602A-602F. The display also presents command buttons 604, 606 and 608, allowing a user to work on a selected object, close the display, or view the selected object, respectively. If a user wishes to work on an object, he or she selects the object, for example by moving a mouse pointer over the appropriate record, and activates the button 604, for example by moving the mouse pointer over the button and clicking the mouse. If the user wishes to view additional details of the object but does not yet wish to take control of the object so as to work on the object, he or she selects the object and activates the button 608.

The various objects represented by the records 602A-602F may have come from different sources and may have been assembled from data and documents that were in numerous different formats when originally collected. However, the work objects as presented by the display 600 are all in a common format and can be accessed and worked on by any user, regardless of where the data making up the work object originated.

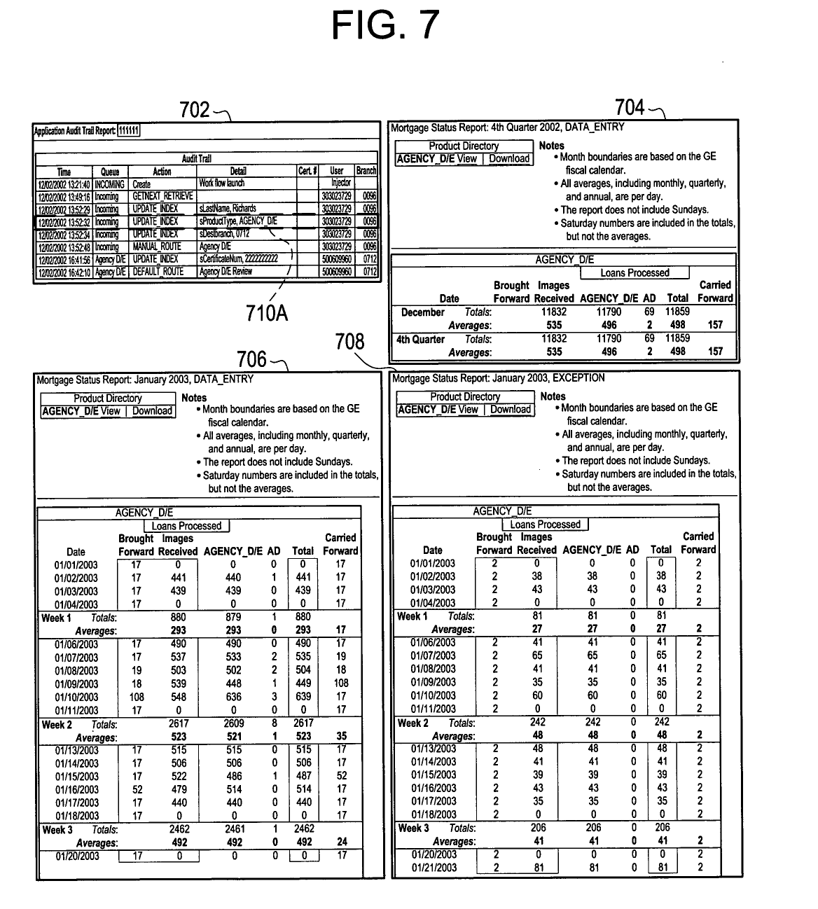

FIG. 7 illustrates a report page 700 providing activity reports for processing of data that may be performed by a system such as the system 100. The page 700 may suitably be prepared using the administrative interface 152 and viewed using the administrator station 150. The page 700 includes an application audit report section 702, an overall data entry report section 704, a detailed data entry report section 706 and an exception report section 708. The various sections illustrated are exemplary, and many different report pages may be prepared using any number of combinations of these or other sections.

The audit report section 702 provides information relating to activities performed in processing of a single mortgage application. The section 702 includes a number of activity records such as the activity record 710. The record 710 includes data and time information, information describing the queue status of the activity, an activity definition, a more detailed explanation of the activity, an identification of the user performing the activity and an identification of the branch where the activity is being performed. The activities are all performed using standardized formats, and therefore the records of activities such as the record 710 may be compiled regardless of the nature and format of the original formats of data and documents involved in carrying out the activities.

The overall data entry report section 704 includes statistical data relating to activity that has been performed during a specific month, with information for the quarter also being provided. The report section 704 provides information as to the number of images received for processing and activities relating to those images. The detailed data entry report section 706 includes statistical data relating to activity during a specific month, showing daily entries divided by week. The exception report section 708 provides information showing daily entries divided by week, with the totals reflecting only activities falling into predetermined categories for exceptions. For all of the sections 704 and 706, the information relating to images and other data presented for processing can be compiled without regard to the original formats of the images and other data.

While the present invention is disclosed in the context of aspects of an embodiment employing a specific system and exemplary web pages, it will be recognized that a wide variety of implementations may be employed by persons of ordinary skill in the art consistent with the above discussion and the claims which follow below.

We claim:

1. A data management system comprising:
an interface module for receiving information to be processed in order to carry out a transaction and to store the information in the form of information packages, the information comprising associated collections of editable data and document images, each collection being able to be received independently from one of a plurality of independent sources, each source providing information for processing in order to facilitate a transaction, the document images being able to be received in any of a variety of formats, each source from which information may be received providing documents in its own formats independently of the other customers; and
a package management module operative to organize the information packages for routing and processing, the package management module being operative to translate each document to a standardized format regardless of the particular format in which the document was received and to store each information package in a standardized format for processing, processing being able to be carried out independently of the format in which the information comprising the package was received.

2. The system of claim 1, wherein the package management module comprises a translation module operative to retrieve documents from an information package and to use one or more of a variety of translation tools to translate the documents into standardized document formats, the translation module examining a profile associated with the source from which the documents were received in order to identify the format of the documents included in the package and select the translation tools to be used to translate the documents.

3. The system of claim 2, wherein the package management module further comprises a transfer module operative to retrieve the data and documents from an information package and to assemble the data and documents into a transfer package for further processing, the transfer package including the data and documents in a standardized format, the transfer module being further operative to create and store a collection of attributes as part of the transfer package, each attribute being associated with one or more elements of data or documents or with the package as a whole, the attributes providing information used in determining routing and processing steps to be taken in processing the information.

4. The system of claim 3, wherein the transfer module is operative to receive a list of documents to be transferred and to include in the transfer package available documents appearing in the list, the transfer module being further operative to perform periodic checks for documents appearing in the list that were not initially available and to add documents to the transfer package as they become available.

5. The system of claim 4, wherein selections made by a user at initiation of a transmission of a transfer package for routing and processing are used to create attributes included in the transfer package.

6. The system of claim 5, wherein predetermined customer preferences are used to create attributes included in the transfer package.

7. The system of claim 6, further comprising a processing server operative to receive a transfer package from the package management module, to assemble the data and documents included in the transfer package into self contained work objects including routing and processing instructions created using the attributes included in the transfer package, and to transmit the work objects for routing and processing according to the instructions.

8. The system of claim 7, further comprising a message queue for receiving instructions and notifications and wherein the package management module is operative to periodically examine the message queue for notifications of newly available documents.

9. The system of claim 8, wherein the package management module is operative to place processing information in the message queue and wherein the interface module is operative to periodically examine the processing information and compile and transmit user reports based on the processing information.

10. The system of claim 9, wherein the processing information includes information describing translation of data and documents and construction and queuing of work objects.

11. The system of claim 10, wherein the processing information includes information relating to processing of work objects being carried out by the processing module.

12. The system of claim 11, wherein the processing module is operative to maintain a processing queue for work objects awaiting processing, the processing queue maintaining priority and identification information about each work object awaiting processing.

13. A method of data management, comprising the steps of:
receiving one or more groupings of information comprising data and associated documents, documents in each grouping of information being able to be received in one of a variety of formats;
assembling each collection of information received into an information package; and
assembling the data and documents in each information package into a transfer package in a standardized format for processing, each document being translated into a standardized format, with the standardized format to which the document is translated being independent of the format in which the document is received.

14. The method of claim 13, wherein translation of the documents is guided by information in a stored profile, the profile including information that can be used to select techniques for translating documents received from a source with which the profile is associated.

15. The method of claim 14, further comprising a step of creating attributes influencing routing and processing of elements of the transfer package and including the attributes in the transfer package.

16. The method of claim 15, further comprising a step of using the elements of the transfer package and the attributes influencing routing and processing of the elements to construct self contained work objects that can be independently routed and processed.

17. The method of claim 15, wherein the stored profile includes instructions and preferences for a source from which the collection of information is received for processing and wherein the attributes influencing routing and processing of elements of the transfer package are created using the preferences and instructions associated with the source.

18. The method of claim 15, further comprising a step of receiving user instructions for routing and processing of elements of the transfer package and wherein the user instructions are employed in creating the attributes influencing routing and processing of elements of the transfer package.

19. The method of claim 15, wherein the step of assembling the data and documents into a transfer package includes reviewing a list of documents to be included in the transfer package and incorporating all available documents included in the list into the transfer package, performing periodic checks for documents that were not initially available and retrieving the documents and incorporating them into the transfer package as they become available.

20. The method of claim 16, further comprising the steps of:
maintaining a processing queue for work objects awaiting processing, the processing queue maintaining priority and identification information about each work object awaiting processing; and
presenting an interface to a user to allow the user to review objects queued for processing and to examine elements comprising the objects.
